(19) United States
(12) Patent Application Publication
(10) Pub. No.: US 2006/0060617 A1
(43) Pub. Date: Mar. 23, 2006

(54) Caps for use in securing palletised etc. loads

(76) Inventors: Hugh David Facey, Sheffield (GB); Derek Boaler, Sheffield (GB); John Makin, South Yorkshire (GB); Lee Mark Giemza, Wakefield (GB)

Correspondence Address: TREXLER, BUSHNELL, GIANGIORGI,;BLACKSTONE & MARR, LTD., 105 WEST ADAMS STREET, SUITE 3600, CHICAGO, IL, 60603, US

(21) Appl. No.: 11/230,394

(22) Filed: Sep. 20, 2005

(30) Foreign Application Priority Data
Sep. 22, 2004 (GB) 0421025.8

(51) Int. Cl. B65D 47/00; B67D 3/00

(52) U.S. Cl. 222/562

(57) ABSTRACT

A cap (1) for use in securing loads on pallets or dollies comprises a one-piece moulding having integral walls (2,3) depending from the generally rectangular top (4), from which walls skirt portions (5,6) further depend, and longitudinal and lateral ribs (7,8) integral with the underside of the top (4), there being at least two areas (9) of the underside of the top at two opposite sides of the cap (1) devoid of rib portions forming compartments for housing strapping mechanisms.

According to another aspect, handholds are provided at each side of the cap (1), formed by rounded-section lengths (19,20), e.g. of alloy tubing, spanning depressions (21,22) in the outside upper edges of the cap moulding, each rounded-section length (19,20) being a close push fit in holes (23) at the ends of the respective depression.

This invention relates to caps for use in securing loads on pallets or dollies and of the type having a generally rectangular top on four sides of which depend skirt portions for embracing the topsides of a load on a pallet or dolly, together with at least two strapping mechanisms incorporated within the cap, one at each of two opposite sides and each including a strapping strand having one end secured to spring-loaded retracting means within the cap, the other end of the strand being provided with a hook for engagement with the platform of a pallet or dolly after the cap has been placed on a load on the pallet or dolly, and tensioning means for the strapping strand in each mechanism operable by a lever movable out from the respective side of the cap.

It is known from WO-A-2004/108552 to form such a cap of two or more mouldings, the principal one of which has a rectangular planar base from the four sides of which the skirt portions depend, there also being walls upstanding from the base defining compartments for housing the strapping mechanisms and providing locations for one or more cover mouldings. In addition to the expense of at least two machines for forming the two or more mouldings, difficulty has been encountered in preventing ingress of water between the principal and cover mouldings. The latter difficulty has also been aggravated by the provision of handhold openings in the or each cover moulding.

The principal object of the invention is to provide a cap having a single moulding of adequate rigidity with provision for incorporation of at least two strapping mechanisms at each of two opposite sides of the cap.

A secondary object of the invention is to provide at least one handhold at each side of the cap without incurring risk of ingress of water into the cap.

According to one aspect of the present invention, a cap of the type initially described is characterised in that it is formed by a one-piece moulding having integral walls depending from the generally rectangular top, from which walls the skirt portions further depend, and longitudinal and lateral ribs integral with the underside of the top, there being at least two areas of the underside of the top at two opposite sides of the cap devoid of rib portions forming compartments for housing the strapping mechanisms.

The longitudinal and lateral ribs may radiate from integral cylindrical portions affording location for the tops of bottles forming a layer at the top of a load, and with each strapping mechanism mounted on a chassis having round indentations for completion of the provision of location for bottle tops. Alternatively, and preferably for greater versatility of use, a separate sheet having round indentations for location of bottle tops may be located within the skirt.

Conveniently, each strapping mechanism comprises a cassette having a chassis (with or without round indentations, as may be required) adapted to be secured within the respective compartment, the depth of the longitudinal and lateral ribs being equal to the overall height of the cassette.

According to another aspect of the present invention, handholds are provided, at least one at each side of the cap, by rounded-section lengths, e.g. of plastics extrusion or preferably alloy tubing, spanning depressions in the outside upper edges of the cap moulding. Conveniently, each rounded-section length is a close push fit in holes at the ends of the respective depression, and an easy push fit through one hole coaxial therewith at one side or end face of the cap moulding, to enable the rounded-section length to be inserted through said side hole, the hole then being sealed with a plug. Outer end portions of two opposite rounded-section lengths may overlie the end faces of the other two rounded-section lengths in the respective adjacent sides, and the inner ends of either pair of rounded-section lengths may be a snap fit into sides of cassettes for the respective strapping mechanisms, to help secure both the cassettes and the rounded-section lengths in the cap moulding. Alternatively, on each side where a strapping mechanism is provided in a cassette, a rounded-section length may abut the cassette at one end, while the other end is abutted by one side of an inserted abutment member another side of which at 90° thereto abuts the end of the rounded-section length along the adjacent side of the cap and nearest to the hole in the side face of the cap moulding.

Each cassette may have a recessed opening to the respective side or end of the cap moulding for accommodating the hook when the strapping strand is retracted into the cap and also the operating lever for the tensioning mechanism for the strapping strand; and sealing means may be provided at the inner side of the recessed opening to surround the strapping strand to deter ingress of water to the retracting means and tensioning means; or each cassette may be of such open-sided construction as to enable any water to drain freely and rapidly therefrom.

Latching means may be provided to secure the cap side-by-side with a similar cap (or caps), so as to increase the stability of adjacent loads on pallets or, especially, on dollies. Such latching means may comprise at least one hinged link having at one end a hole by means of which the link is journalled on one of the rounded-section lengths, the other end of the link having a hook to snap onto a rounded-section length of a similar cap. There are preferably two such links, one at each of two opposite sides; and the or each link is preferably normally stowed within a recess extending at right angles to the depression spanned by the rounded-section length on which the link is hinged.

An embodiment of the invention will now be described, by way of example only, with reference to the accompanying drawings in which:—

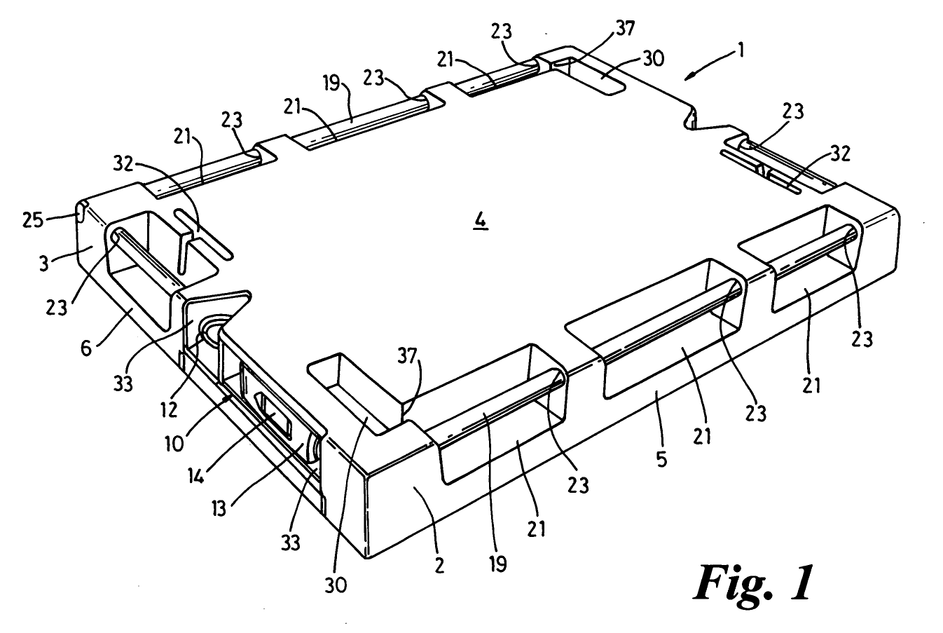

FIG. 1 is a perspective view of a cap in accordance with the invention as viewed from above and one end;

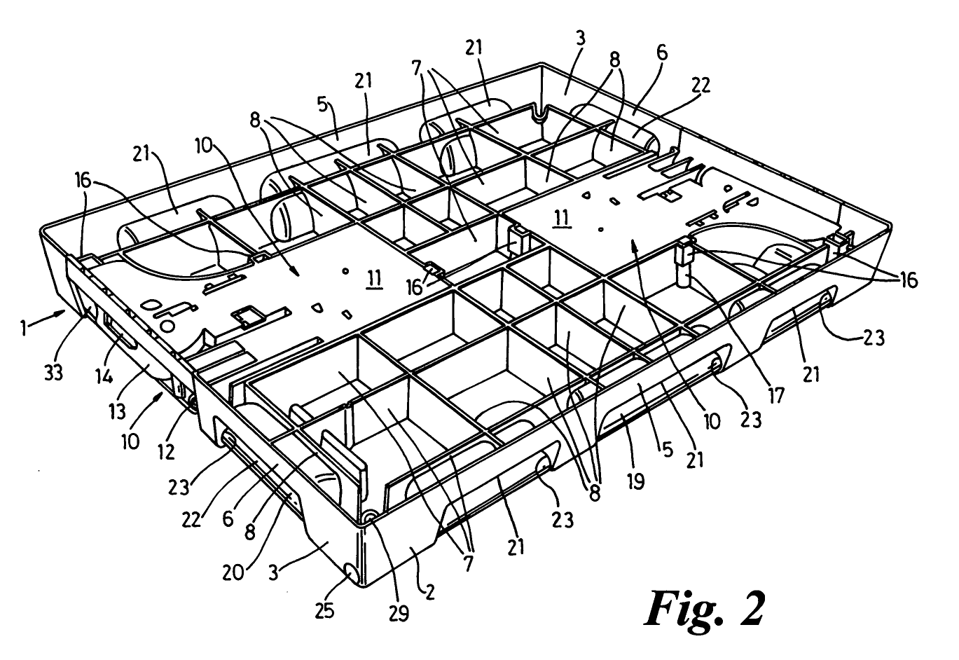

FIG. 2 is a perspective view of the underside of the cap as viewed from one end;

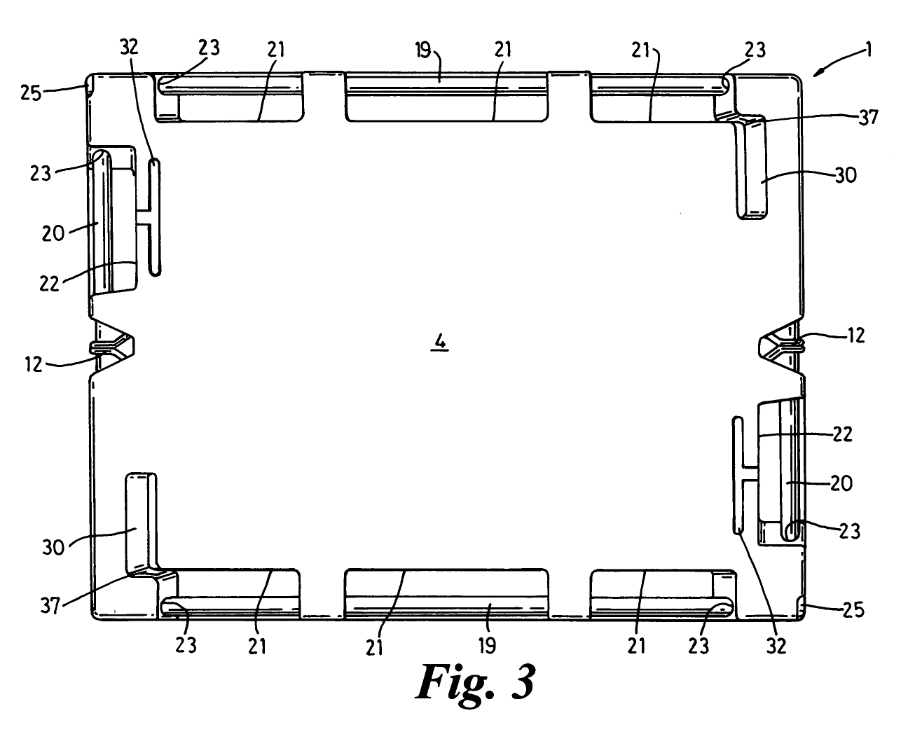

FIG. 3 is a view of the cap from directly above;

FIG. 4 is a view of the cap from directly below;

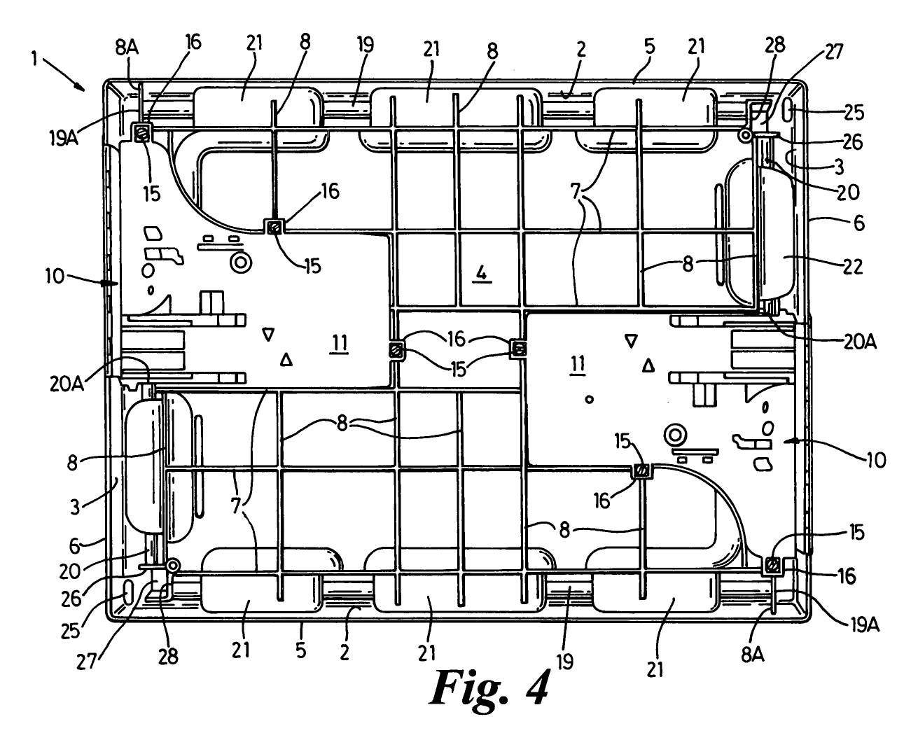

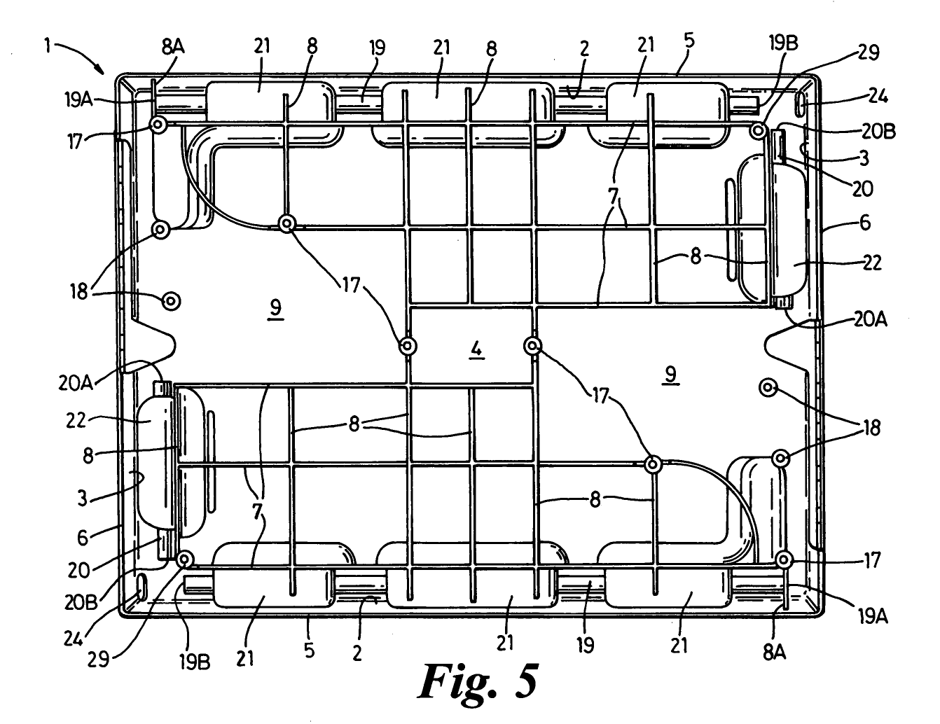

FIG. 5 corresponds to FIG. 4 but without the cassettes housing the strapping mechanisms and without the abutment members for the rounded-section lengths;

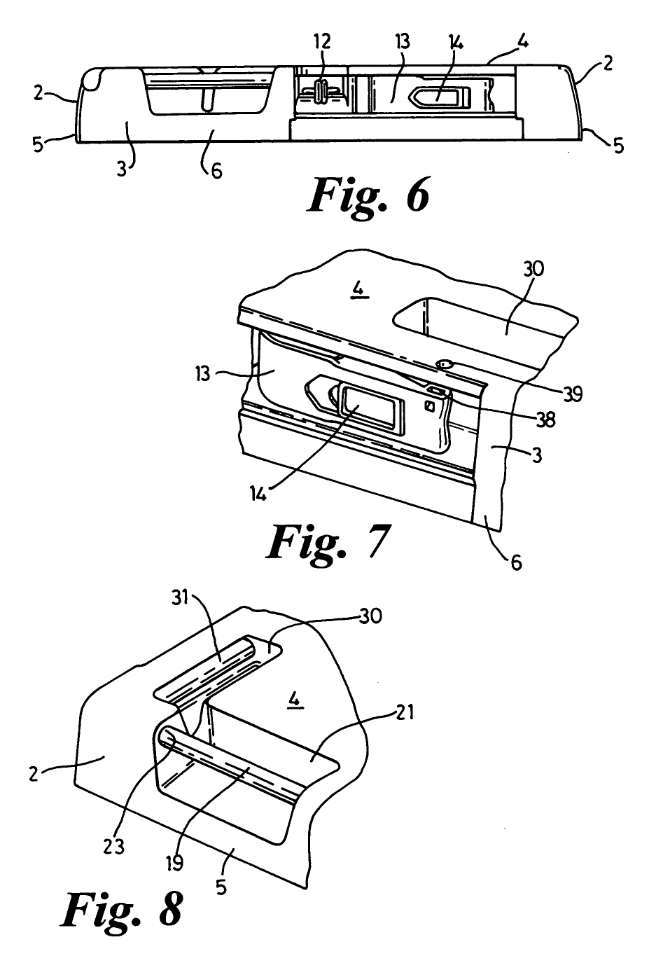

FIG. 6 is an end elevation of the cap;

FIG. 7 is a fragmentary view of the cap showing means for fitting of security seals;

FIG. 8 is a fragmentary view of a corner of the cap showing an additional handhold;

FIG. 9 is a further fragmentary view of the cap showing latching means for securing the cap side-by-side with a similar cap, the latching means being shown in its stowed position.

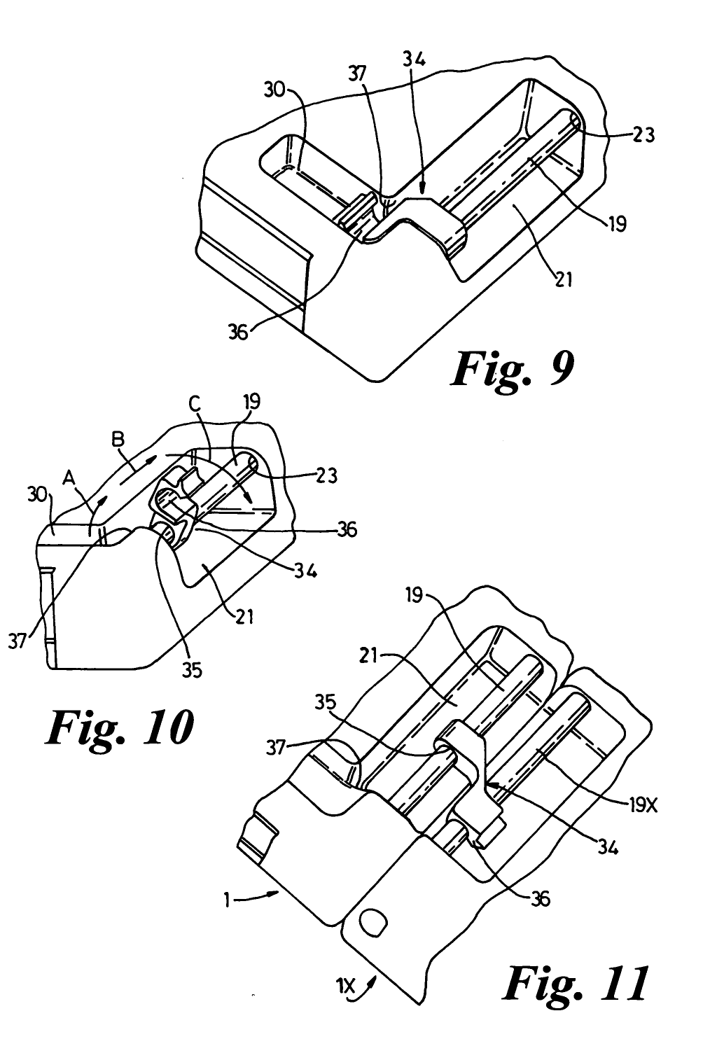

FIG. 10 corresponds to part of FIG. 9 but illustrates how the latching means is moved towards operative position; and

FIG. 11 is yet another fragmentary view of the cap but showing it secured to a similar cap by the latching means.

Referring to FIGS. 1 to 6, the cap 1 for use in securing loads (not shown) on pallets or dollies (not shown) is formed by a one-piece moulding having integral walls 2 at the sides and 3 at the ends depending from the generally rectangular top 4, from which walls skirt portions 5, 6 further depend, and formed integrally with the underside of the top are longitudinal and lateral ribs 7, 8 respectively, there being two areas 9 (see FIG. 5) of the underside of the top at two opposite sides (or ends) of the cap devoid of rib portions forming compartments for housing strapping mechanisms.

It will be seen that the ribs 7, 8 are web-like so as to minimise the weight of plastics from which the cap is moulded, without compromising the rigidity of the cap.

The strapping mechanisms are housed in cassettes 10 basically similar to those in WO-A-2004/108552 the content of which is imported into this description, the only parts of the cassettes being visible in the accompanying drawings being the chassis 11, hooks 12 and the actuating levers 13 with their release sliders 14. The cassettes 10 are secured in the cap by means of screws 15 through hollow lugs 16 integral with the chassis 11 screwing into bosses 17 integral with the underside of the op 4 and some of the ribs 7, 8. Further bosses 18 are provided for location of parts (not visible) of the strapping mechanisms.

In accordance with another aspect of the invention, handholds are provided both at the sides and the ends of the cap, by rounded-section lengths 19, 20, e.g. of plastics, but preferably alloy tubing, spanning depressions 21, 22 in the outside upper edges of the cap 1, each rounded-section length being a close push fit in holes 23 at the ends of the respective depressions. The rounded-section lengths 19 adjacent the sides 2 of the cap are an easy push fit through holes 24 (see particularly FIG. 5) at the ends 3 of the cap, to enable the lengths 19 to be inserted until their leading ends 19A abut portions 8A of transverse ribs, the holes 24 then being sealed by plugs 25. Each of the shorter rounded-section lengths 20 adjacent the ends 3 of the cap is inserted from the areas 9 before the respective cassette 10 is put in place, then the trailing end 20A abuts the side of the cassette while the leading end 20B abuts one side 26 of an inserted abutment member 27, and the trailing end 19B of the length 19 abuts another side 28 of the abutment member at 90° to the side 26. The inserted abutment members are secured by screwing to bosses 29 integral with the underside of the top 4 of the cap 1 at junctions between pairs of the ribs 7 and 8.

Further handholds 30 are provided adjacent the ends 3 by further depressions in the top 4 behind the levers 13, and the grip in these can be further enhanced by affixing in each a semi-cylindrical insert 31 as shown in FIG. 8.

A further slot-like depression 32 is also provided adjacent each end 3 behind the depression 22, for affixing to the cap a cord displaying data relevant to a load secured by the cap 1 to a pallet or dolly.

Each cassette 10 has a recessed opening 33 to the respective end 3 of the cap moulding for accommodating the hook 12 when the strapping strand (not visible) is retracted into the cap 1, i.e. into the cassette 10, and also the operating lever 13 for the tensioning mechanism (not visible) for the strapping strand. Sealing means such as brush curtains, may be provided at the inner side of the recessed opening 33 to deter ingress of water to the retracting means and tensioning means, but in view of the cap being formed with a one-piece moulding without any openings on top, it suffices to provide each cassette with such open-sided construction as to enable any water to drain freely and rapidly therefrom.

As shown by FIGS. 9 to 11, latching means may be provided to secure the cap 1 side-by-side with a similar cap 1X (or caps), so as to increase the stability of adjacent loads on pallets or, especially on dollies, the latching means taking the form of at least one link 34 having at one end a hole 35 by means of which the link is journalled on one of the rounded-section lengths 19, the other end of the link having a hook 36 to snap on to a rounded-section length 19X of the similar cap 1X. There would preferably be two such links per cap, one at each of two opposite sides; and the or each link preferably normally stowed within a recess extending at right angles to the depression 21 spanned by the rounded-section length 19 on which the link is hinged, and—in the embodiment shown—the recess is formed by the handhold 30 with an opening 37 to the depression 21, and the link 34 is cranked to fit as shown in FIG. 9 when stowed. To bring the link to operative position it is swung up, as indicated by the arrow A in FIG. 10, out of the recess 30, then slid along the rounded-section length 19, as indicated by the arrow B, then swung down as indicated by the arrow C, for engagement with the rounded-section length 19X of the cap 1×, or, alternatively, the hook 36 may be snapped onto a rail inside a van to secure the load against movement during transporting.

FIG. 7 shows a small hole 38 in the operating lever 13 of one cassette 10 and a small hole 39 in the cap moulding in register with the hole 38 for fitting of a security seal (not shown).

What we claim is:

1. A cap for use in securing loads on pallets or dollies and of the type having a generally rectangular top on four sides of which depend skirt portions for embracing the topsides of a load on a pallet or dolly, together with at least two strapping mechanisms incorporated within the cap, one at each of two opposite sides and each including a strapping strand having one end secured to spring-loaded retracting means within the cap, the other end of the strand being provided with a hook for engagement with the platform of a pallet or dolly after the cap has been placed on a load on the pallet or dolly, and tensioning means for the strapping strand in each mechanism operable by a lever movable out from the respective side of the cap, characterised in that the cap is formed by a one-piece moulding having integral walls depending from the generally rectangular top, from which walls the skirt portions further depend, and longitudinal and lateral ribs integral with the underside of the top, there being at least two areas of the underside of the top at two opposite sides of the cap devoid of rib portions forming compartments for housing the strapping mechanisms.

2. A cap as in claim 1, characterised in that the longitudinal and lateral ribs radiate from integral cylindrical portions affording location for the tops of bottles forming a layer at the top of a load, and with each strapping mechanism mounted on a chassis having round indentations for completion of the provision of location for bottle tops.

3. A cap as in claim 1, characterised in that each strapping mechanism comprises a cassette having a chassis adapted to be secured within the respective compartment, the depth of the longitudinal and lateral ribs being equal to the overall height of the cassette.

4. A cap as in claim 1, characterised in that handholds are provided, at least one at each side of the cap.

5. A cap as in claim 4, characterised in that the handholds are formed by rounded-section lengths spanning depressions in the outside upper edges of the cap moulding.

6. A cap as in claim 5, characterised in that each rounded-section length is a close push fit in holes at the ends of the respective depression, and an easy push fit through one hole coaxial therewith at one side or end face of the cap moulding, to enable the rounded-section length to be inserted through said side hole, the hole then being seated with a plug.

7. A cap as in claim 6, characterised in that outer end portions of two opposite rounded-section lengths overlie the end faces of the other two rounded-section lengths in the respective adjacent sides.

8. A cap as in claim 7, characterised in that the inner ends of either pair of rounded-section lengths are a snap fit into sides of cassettes for the respective strapping mechanisms, to help secure both the cassettes and the rounded-section lengths in the cap moulding.

9. A cap as in claim 6, characterised in that on each side where a strapping mechanism is provided in a cassette, a rounded-section length abuts the cassette at one end, while the other end is abutted by one side of an inserted abutment member another side of which at 90° thereto abuts the end of the rounded-section length along the adjacent side of the cap and nearest to the hole in the side face of the cap moulding.

10. A cap as in claim 1, characterised in that each cassette has a recessed opening to the respective side or end of the cap moulding for accommodating the hook when the strapping strand is retracted into the cap and also the operating lever for the tensioning mechanism for the strapping strand.

11. A cap as in claim 10, characterised in that sealing means is provided at the inner side of the recessed opening to surround the strapping strand to deter ingress of water to the retracting means and tensioning means.

12. A cap as in claim 10, characterised in that each cassette is of such open-sided construction as to enable any water to drain freely and rapidly therefrom.

13. A cap as in claim 1, characterised in that latching means is provided to secure the cap side-by-side with a similar cap so as to increase the stability of adjacent loads on pallets or, especially, on dollies.

14. A cap as in claim 5, characterised in that latching means is provided comprising at least one hinged link having at one end a hole by means of which the link is journalled on one of the rounded-section lengths, the other end of the link having a hook to snap onto a rounded-section length of a similar cap.

15. A cap as in claim 14, characterised in that two such links are provided, one at each of two opposite sides.

16. A cap as in claim 14 or claim 15, characterised in that the or each link is normally stowed within a recess extending at right angles to the depression spanned by the rounded-section length on which the link is hinged.

17. A cap as in claim 16, characterised in that the recess is formed by a handhold depression.

18. A cap as in claim 17, characterised in that the handhold depression forming the recess lies behind the operating lever of a cassette and has an opening to a handhold depression on an adjacent side, the link being cranked to fit through the opening.

19. A cap as in claim 1, characterised in that a small hole is provided in the or each operating lever and a small hole is provided in the cap moulding in register with the first hole for fitting of a security seal.
